(19) United States
(12) Patent Application Publication
(10) Pub. No.: US 2007/0056472 A1
(43) Pub. Date: Mar. 15, 2007

(54) Molded resin component

(75) Inventors: Kouhei Chouraku, Kawasaki (JP); Yasushi Yui, Kawasaki (JP); Shingo Yamaguchi, Kawasaki (JP); Hiroshi Takahashi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/311,685

(22) Filed: Dec. 20, 2005

(30) Foreign Application Priority Data
Sep. 14, 2005 (JP) 2005-266896

(51) Int. Cl. C04B 28/26

(52) U.S. Cl. 106/610

(57) ABSTRACT

A disclosed resin molded component includes a molded substrate including a biodegradable resin, and a coating film applied on a surface of the molded substrate. The coating film includes a blended material having a petroleum coating material and a natural material blended therein.

### BACKGROUND OF THE INVENTION

1. Field of the Invention

The present invention generally relates to a molded resin component using a biodegradable resin, and more particularly to a molded resin component having a coating applied on a surface of a resin substrate formed of a degradable resin.

2. Description of the Related Art

As the importance of protecting resources and the environment becomes greater, the concerns for handling (utilize) used or worn out products and components (e.g. electronic products, containers, etc.) are growing in the stage of product development.

Meanwhile, plastics (e.g. polyethylene, polystyrene) which use petroleum as raw material are known to have benefits such as light-weightness, good hardness, and excellent longevity. However, such plastics release high heat and cause damage to an incineration facility when subjected to incineration, and thereby lead to generation of hazardous substances such as dioxin. Therefore, most plastics are disposed of by being buried in the ground. Since plastic products (e.g. plastic containers) have a large volume with respect to weight, a vast amount of space is required for disposing of the plastic products. Furthermore, since the conventional plastics hardly decompose in the ground, the disposed of plastics (particularly those that are not thoroughly buried in the ground) are visually unpleasant, and lead to various kinds of environmental destruction (e.g. endangering wild animals). Therefore, the disposal of the conventional plastics after their use is a serious concern.

Meanwhile, molded plastic products using petroleum as raw material can have their appearance, peel-resistance, and scratch-resistance improved by applying a petroleum coating material (e.g. acrylic coating material) thereon. Although it is possible to apply a petroleum coating material on the surface of a molded biodegradable resin product, the coating of the petroleum coating material may cause the biodegradation rate of the molded biodegradable resin product to become slower. Furthermore, the petroleum coating material is unable to decompose in the ground and thereby may be left remaining in the ground.

In recent years and continuing, research is made for a biodegradable resin having a high biodegradation rate in the ground and in the water. The biodegradation rate of the biodegradable resin is faster than that of a conventional plastic. Here, the biodegradable resin is a plastic which can be decomposed by microbes inside the ground or water. For example, in a case where the biodegradable resin is substantially completely decomposed by microbes, the biodegradable resin is transformed into water and carbon dioxide. The biodegradable resin includes, for example, polylactic acid and poly (ε-caprolactone) which are synthesized with starch. Currently, vigorous research is being conducted on biodegradable resin material and products using the biodegradable resin material.

For example, molded biodegradable resin products applied with various decorations and coatings applied are proposed (Japanese Laid-Open Patent Application No. 2004-148806, Japanese Laid-Open Patent Application No. 2004-41526). In Japanese Laid-Open Patent Application No. 2004-148806, a craft product is disclosed in where an adhesive agent is applied as a coating on the surface of a molded biodegradable resin substrate, a decorative material (e.g. gold foil) is adhered on the adhesive agent coating, and a protective film is formed on the surface of the decorative material. In Japanese Laid-Open Patent Application No. 2004-41526, a dharma doll formed of a biodegradable resin and Japanese paper is disclosed in where the surface of the dharma doll is coated with a biodegradable coating material.

### SUMMARY OF THE INVENTION

The present invention may provide a molded resin component that substantially obviates one or more of the problems caused by the limitations and disadvantages of the related art.

Features and advantages of the present invention are set forth in the description which follows, and in part will become apparent from the description and the accompanying drawings, or may be learned by practice of the invention according to the teachings provided in the description. Objects as well as other features and advantages of the present invention will be realized and attained by a molded resin component particularly pointed out in the specification in such full, clear, concise, and exact terms as to enable a person having ordinary skill in the art to practice the invention.

To achieve these and other advantages and in accordance with the purpose of the invention, as embodied and broadly described herein, the invention provides a resin molded component including: a molded substrate including a biodegradable resin; and a coating film applied on a surface of the molded substrate; wherein the coating film includes a blended material having a petroleum coating material and a natural material blended therein.

In the resin molded component according to an embodiment of the present invention, the natural material may have a biodegradability rate that is greater than that of a synthetic resin included in the petroleum coating material.

In the resin molded component according to an embodiment of the present invention, the molded substrate and the coating film may have an adhesive layer provided therebetween.

In the resin molded component according to an embodiment of the present invention, the natural material may contain a substance obtained from a plant, wherein the substance includes at least one of a sap, a pitch, a tallow, a beeswax, a glue, and an albumen.

Furthermore, the present invention provides a resin molded component including: a molded substrate including a biodegradable resin; an adhesive layer applied on a surface of the molded substrate; and a coating film coated on a surface of the adhesive layer; wherein the principal component of the coating film is a coating material including a natural material.

Other objects and further features of the present invention will be apparent from the following detailed description when read in conjunction with the accompanying drawings.

### BRIEF DESCRIPTION OF THE DRAWINGS

FIG. 1 is a cross-sectional view showing a portion of a molded resin component according to a first embodiment of the present invention;

FIG. 2 is a table showing the properties of coating films used in Sample A;

FIG. 3 is a table showing the properties of coating films used in Sample B;

FIG. 4 is a table showing the properties of coating films used in Sample C;

FIG. 5 is a table showing the properties of coating films used in Sample D;

FIG. 6 is a table showing the properties of coating films used in Sample E;

FIG. 7 is a table showing the properties of coating films used in Sample F; and

FIG. 8 is a cross-sectional view showing a portion of a molded resin component according to a second embodiment of the present invention.

### DESCRIPTION OF THE PREFERRED EMBODIMENTS

In the following, embodiments of the present invention are described with reference to the accompanying drawings.

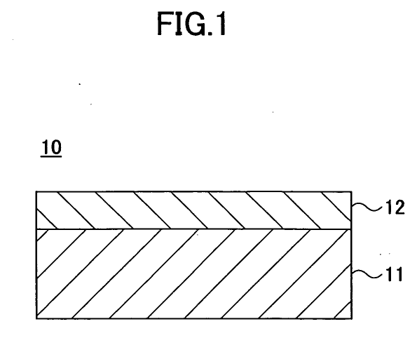

FIG. 1 is a cross-sectional view showing a portion of a molded resin component 10 according to a first embodiment of the present invention. In FIG. 1, the molded resin component 10 according to the first embodiment of the present invention includes a molded substrate 11 including a biodegradable resin and a coating film 12 applied at least on a portion of the surface of the molded substrate 11.

The molded resin component 10 is not to be limited to a particular shape or for a particular purpose. The molded resin component 10 may be, for example, a housing of an electronic device (e.g. personal computer, mobile phone), a container, a film, a sheet, or a bag.

The biodegradable resin may be, for example, a biodegradable polyester resin. One representative example of the resin of the biodegradable polyester resin is polylactic acid. The polylactic acid is a homopolymer of lactic acid. Other examples of the biodegradable polyester resin include, polyester obtained from, for example, a hydroxycarboxylic acid (e.g. glycolic acid, glyceric acid, 3-hydroxybutylic acid, tartaric acid, citric acid), a polycarboxylic acid (e.g. succinic acid, adipic acid), or lactone, or being a copolymer obtained from the foregoing monomers.

As for further examples of the biodegradable polyester resin, there is, for example, polyethylene succinate, polybutylene succinate, polybutylene succinate adipate, polybutylene succinate adipate terephthalate, polybutylene succinate terephthalate, polybutylene succinate carbonate, polyadipate terephthalate, and polytetramethylene adipate terephthalate.

As for biodegradable resins, there is, for example, a polysaccharide polymer material (e.g. starch, cellulose, chitosan, pullulan) and polyvinyl alcohol. The cellulose may be, for example, cellulose acetate or cellulose triacetate.

Among the foregoing biodegradable resins, a polylactic acid, a polylactic acid alloy, a polylactic acid cellulose, a polyvinyl alcohol, or a cellulose acetate is a preferable resin material which can be used to provide a sufficiently hard housing of an electronic device, for example.

The coating film 12 according to an embodiment of the present invention includes a coating material comprising a natural material and a petroleum coating material. Owing to the microbes contained in the natural material, the biodegradation rate of the natural material is considerably faster than that of the petroleum coating material. Since the coating film 12 has such natural material contained therein, the coating film 12 can attain a higher biodegradability and the amount of residue remaining after biodegradation (i.e. material which could not be biodegraded) can be reduced. Furthermore, owing to the biodegradation of the natural material inside the coating film 12, pores are formed in the coating film 12 for enabling various microbes of nature (microbes inside dirt or water) to easily reach the molded substrate 11. Accordingly, the coating film 12 does not obstruct the biodegradation of the molded substrate 11, but rather assists in the biodegradation of the molded substrate 11.

The natural material may be, for example, a plant-based natural material or an animal-based natural material. The plant-based natural material is not limited to a particular plant type. For example, the plant-based natural material may be from a single plant or a combination of plants. Furthermore, the plant-based natural material may also include extracted material, for example, sap, or pitch. More specifically, the plant-based natural material may include, for example, Japanese lacquer, pine resin, gum Arabic, or natural rubber. As for the animal-based natural material, there is, for example, tallow, beeswax, glue (animal glue), or albumen.

The petroleum coating material according to an embodiment of the present invention includes, for example, a petroleum-based synthetic resin (manufacturing method described in detail below). The biodegradation rate of the synthetic resin is considerably slower than that of the natural material.

Next, the method of manufacturing the molded resin component 10 according to an embodiment of the present invention is described.

First, a resin composition including a biodegradable resin is prepared. In the biodegradable resin of the resin composition may be added various additives, modifiers, and fillers (e.g. plasticizers, antistatic agents, antioxidants, pigments, ultraviolet absorbers), preferably to the extent that the objective of the present invention can be achieved. The method for manufacturing the resin composition is not limited to a particular method. For example, the resin composition may be manufactured by using a melt kneading machine. The melt kneading machine may be, for example, an extruder (e.g. uniaxial extruder, biaxial extruder), a Banbury mixer, a Brabender, or a kneader. In one example, the materials of the resin components may be melted and kneaded together in a lump (substantially at the same time). In another example (e.g. a case of adding an inorganic powder such as a pigment), a portion of the materials of the resin composition may be kneaded with an inorganic powder beforehand, and then the kneaded materials can be further melted and kneaded with the remaining materials of the resin composition and other materials.

Then, the resin composition is molded to form the molded substrate 11 having a desired shape. The shape of the molded substrate 11 is not limited to a particular shape. For example, the molded substrate 11 may be shaped as a housing, a container, a film, or a sheet. The housing or the container may be formed by using, for example, an injection molding method, a compression molding method, or an extrusion molding method. The film or the sheet may be formed by using, for example, a vacuum molding method, a compression molding method, or a melt drawing method.

Furthermore, in addition to the preparation of the material for the molded substrate 11, a coating material for the coating film 12 is prepared. The coating material includes, for example, a petroleum-based synthetic resin, a natural material, a pigment, a curing agent, and an organic solvent. The coating material is obtained, for example, by kneading/dispersing a synthetic resin, a pigment, and a small amount of organic solvent, then adding an organic solvent thereto, and then mixing the materials into a solid. Furthermore, in a case where the materials for the coating material have low viscosity, the materials may simply be mixed/stirred (agitated).

The synthetic resin may be, for example, nitrocellulose, phenol resin, alkyd resin, polyvinyl chloride, amino resin (e.g. urea resin, melamine resin), epoxy resin, acrylic resin, fluororesin, or silicone resin. The natural material may be any one or combination of the aforementioned natural materials used for the coating film 12 (e.g. plant-based natural material, animal-based natural material).

The pigment may be, for example, a color pigment including organic pigments (e.g. azo pigment, quinacridone pigment, phthalocyanine pigment) and inorganic pigments (e.g. titanium oxide pigment, red iron oxide pigment, carbon black pigment). The pigment may also be, for example, an extender pigment (filler pigment) such as calcium carbonate, silica, or talc.

Then, the coating material is applied on the surface of the molded substrate 11. The method for applying the coating material is not limited to a particular method. For example, the coating material may be applied by using a brush, a roller, an air spray, or an airless spray. Then, the coating material applied on the surface of the molded substrate 11 is dried at room temperature or heated to a predetermined temperature, for example. The procedures of applying the coating material and drying/heating the applied coating material may be repeated. Thereby, the hardness of the coating film 12 can be enhanced. In addition, the surface of the coating film 12 may be smoothened by using sandpaper, for example. Furthermore, the coating procedure may further be performed on the coating film after the smoothing procedure. By executing the above-described procedures, the molded resin component 10 including the molded substrate 11 and the coating film 12 applied on the molded substrate 11 can be completed.

Next, various experiments performed on the molded resin component 10 according to an embodiment of the present invention are described.

[Experiment No. 1]

In this experiment, a specimen formed of a polylactic acid (which is a resin having biodegradability) is employed as the molded substrate 11, and a coating material (coating film) including a natural material is applied on the specimen. Accordingly, the hardness of the coating film, the adhesion between the specimen and the coating film, and the endurance of the coating film were tested.

More specifically, the specimen is a planar member formed of a polylactic acid (length 150 mm×width 70 mm×thickness 3 mm, Manufactured by Toray, Product No. PHF-6). The coating materials applied on the specimen are Coating Materials A-F (described below). The natural materials used in Coating Materials A-F are lacquer (Japanese lacquer), pine resin, and natural rubber. The petroleum coating materials used in the Coating Materials A-F are acrylic coating material and epoxy coating material. The proportions of the Coating Materials A-F are described below. The ratio (%) of the mixture (blend) of the natural material and the petroleum coating material of the Coating Materials A-F is expressed as:
natural material (by weight)/petroleum coating material (by weight)×100.

In the experiment, the mixture ratio (blend ratio) is incremented 10% in a range of 0% to 100%.

[Coating Material A]

Lacquer (100% Natural lacquer) (Manufactured by Hariyo Shikko Co.)
Acrylic coating material Uni 2000 (Manufactured by Mikasa Paint Co.)
   Component Ratio: acrylic resin 30% by weight organic solvent 70%
      [Coating Material B]
Lacquer

(Same as Coating Material A)
Epoxy coating material Bonde 88 (Manufactured by Mikasa Paint Co.)
   Component Ratio: epoxy resin 30% by weight organic solvent 70%
      [Coating Material C]
Pine resin Rosin (Manufactured by Harima Kasei Co.)
   Component Ratio: Pine resin 100%
Acrylic coating material

(Same as Coating Material A)

[Coating Material D]

Pine resin

(Same as Coating Material C)
Epoxy coating material

(Same as Coating Material B)

[Coating Material E]

Natural rubber MG-10S (Manufactured by Regitex Co.)
   Component Ratio: MG-S (methylmethacrylate graft/natural rubber polymer) 50% Organic solvent 50%
Acrylic coating material

(Same as Coating Material A)

[Coating Material F]

Natural rubber

(Same as Coating Material E)
Epoxy coating material

(Same as Coating Material B)

With each of the above-described Coating Materials A-F, a stirring machine (agitation mill) is used for stirring (agitating) the natural material and the petroleum coating material and dissolving the natural material. After the natural material is dissolved, the Coating Materials A-F are applied on a specimen by a spraying method. The specimen is dried at a temperature of 60° C. and 160° C. for 30 minutes and 120 minutes, respectively. Accordingly, Samples A-F (Specimens A-F) are obtained. Next, the following tests are performed.

(1) Hardness Test

The hardness test is performed by a scratching test according to the JIS K 5400 (8.4.2) testing standard. In the hardness test, a pencil (Product Name: UNI, Manufactured by Mitsubishi Pencil Co.) is set in an angle of 45 degrees with respect to the surface of the coating film of the specimen and is pressed against the surface of the coating film with a load (weight) of 1 kg. In such state, the pencil is then moved across the surface of the coating for a distance of 30 mm. Then, a visual inspection is conducted on the specimens for determining whether the surface of the coating film is scratched (damaged). The hardness is evaluated according to the hardness level of the pencil which has left a scratch (damage) on the surface. If the hardness level of the pencil is equal or higher than “H”, the hardness is evaluated as satisfactory.

(2) Adhesion Test

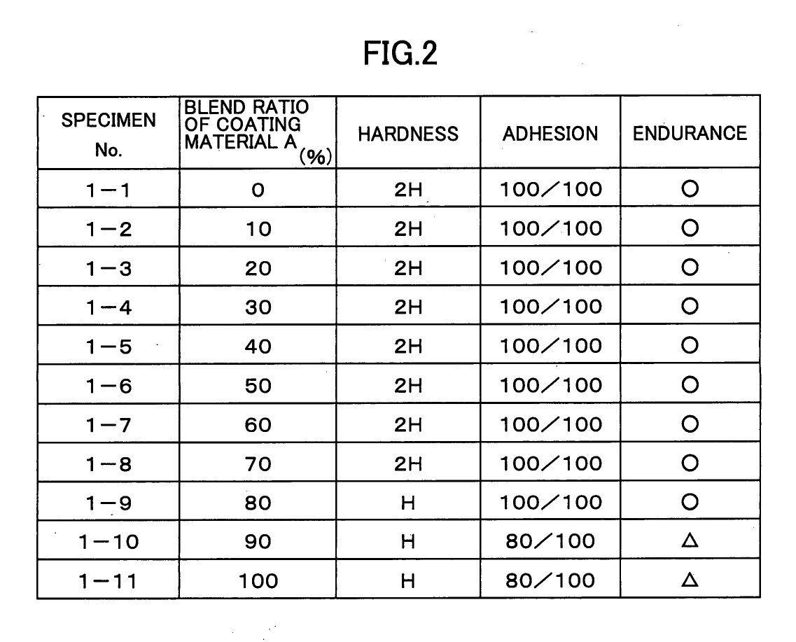

100 squares (each square: 1 mm×1 mm) are formed on the surface of the specimen by using a cutter. Then, an adhesive tape (Product Name: P.781, Manufactured by Permacel Co.) is applied onto the surface of the specimen. Then, the adhesive tape is separated from the surface of the specimen. Then, the number of squares which are not (or barely) peeled/chipped are counted. The specimen is evaluated as acceptable (allowable) when the number of such squares is 80 squares or more (indicated as “80/100” in FIGS. 2-7).

(3) Endurance Test

The endurance test is conducted by storing the specimens in an atmosphere having high temperature and high humidity. More specifically, the specimens are stored in an atmosphere having a temperature 60° C. and a humidity of 90% RH for 240 hours.

The results of the above-described tests performed on the coating films of Samples A-F are shown in FIGS. 2-7.

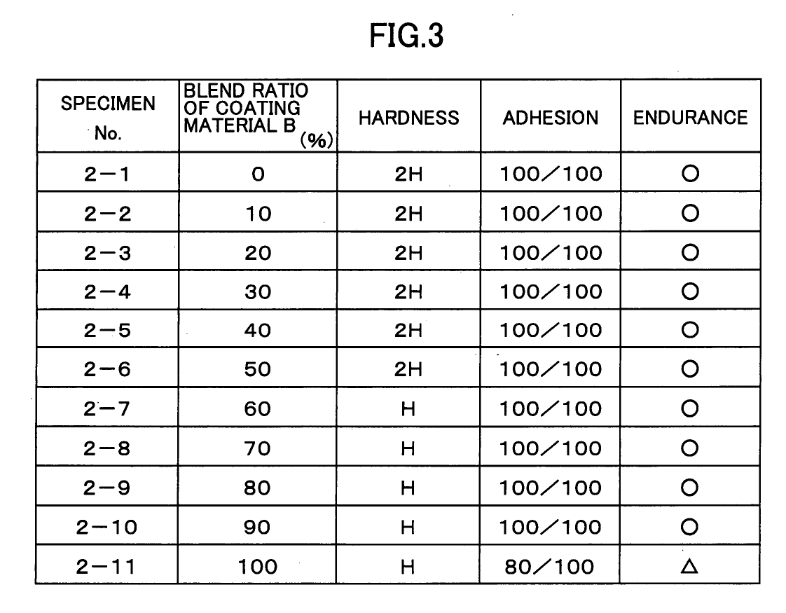

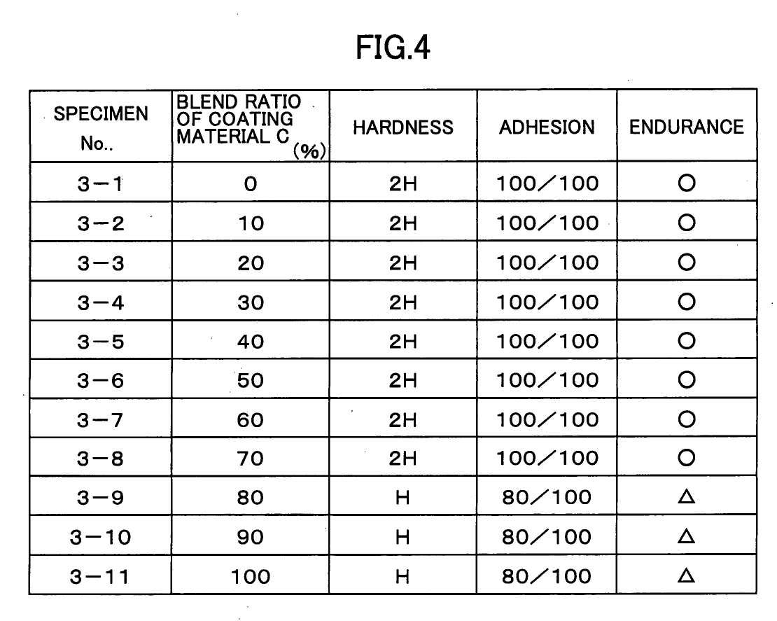

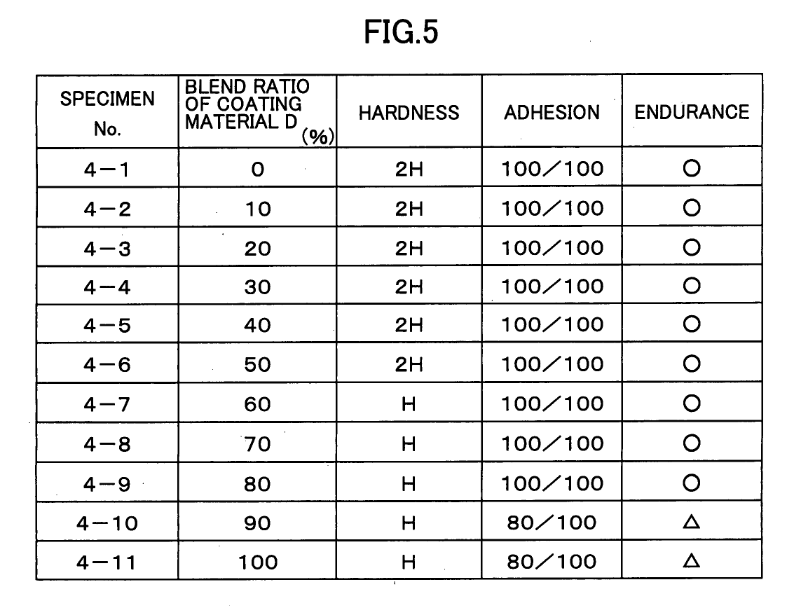

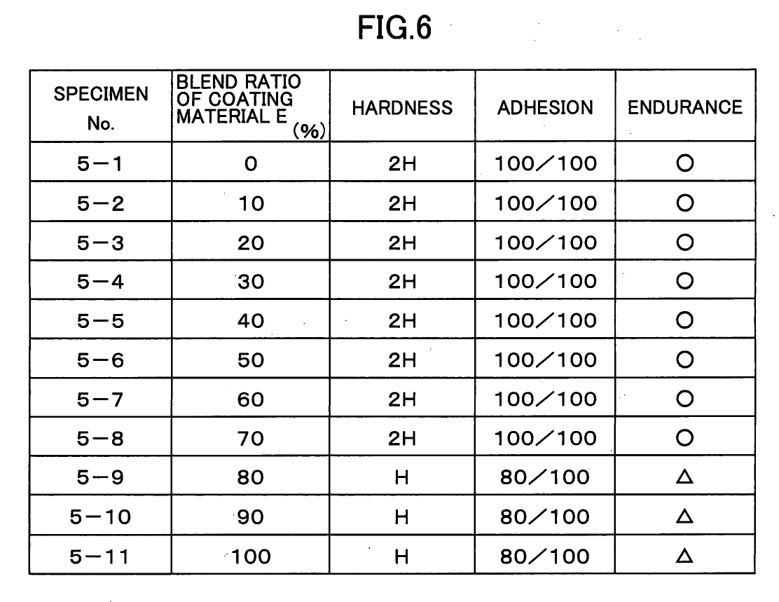

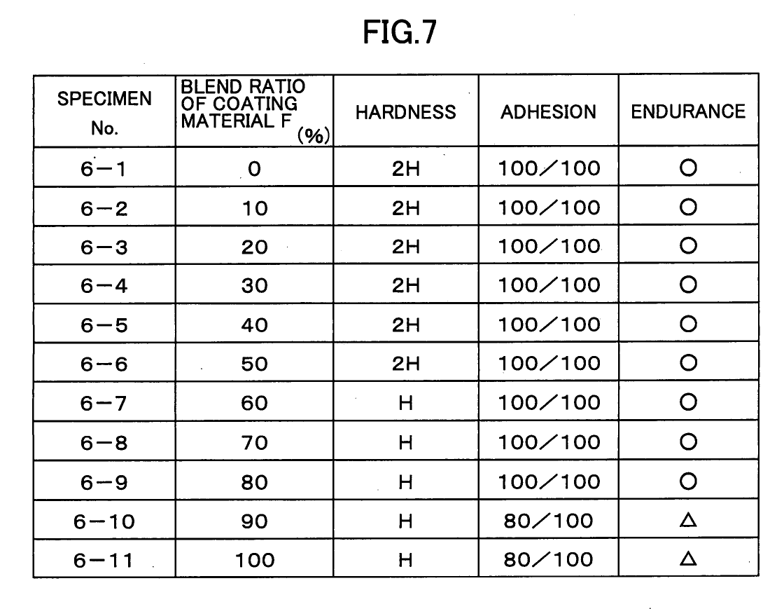

The results in FIGS. 2-7 show that the samples having a coating film including a small amount of natural material (i.e. samples having a coating material of a low blend ratio) exhibit satisfactory results from the aspects of hardness, adhesion, and endurance. Compared to the samples having a coating film including a small amount of natural material, the samples having a coating film including a large amount of natural material (i.e. samples having a coating material of a high blend ratio) provide relatively low hardness, adhesion, and endurance. Nevertheless, the samples having a coating film including a large amount of natural material still exhibit hardness, adhesion, and endurance that are acceptable (allowable). Hence, the test results shown in FIGS. 2-7 show that a coating surface having a coating film with a mixture of a natural material and a petroleum coating material (specimens 1-2 through 1-10 in FIG. 2, specimens 2-2 through 2-10 in FIG. 3, specimens 3-2 through 3-8 in FIG. 4, specimens 4-2 through 4-9 in FIG. 5, specimens 5-2 through 5-8 in FIG. 6, and specimens 6-2 through 6-9 in FIG. 7) exhibits satisfactory hardness, adhesion, and endurance which are relatively equal to those of a specimen having a surface coated only with a petroleum coating material (specimens 1-1 in FIG. 2, specimen 2-1 in FIG. 3, specimen 3-1 in FIG. 4, specimen 4-1 in FIG. 5, specimen 5-1 in FIG. 6, and specimen 6-1 in FIG. 7). Furthermore, the natural material included in the coating film allows microbes to form pores in the molded substrate on which the coating film is applied. Thereby, the coating film applied on the molded substrate does not obstruct the biodegradation of the molded substrate, but rather assists the biodegradation of the molded substrate. Accordingly, satisfactory biodegradation can be attained for a molded resin component having a coating film with sufficient physical properties (e.g. hardness, adhesion, endurance).

Furthermore, the inventors of the present invention find that the rate of biodegradation for a coating film with a blend ratio ranging from 10% to 90% is substantially equal to a coating film with a blend ratio of 100%. Furthermore, it is also found that biodegradation of the coating film occurs even when the blend ratio is 1%. Therefore, one of the advantages of the present invention can be attained when the coating film has a blend ratio preferably ranging from 1% to 90%.

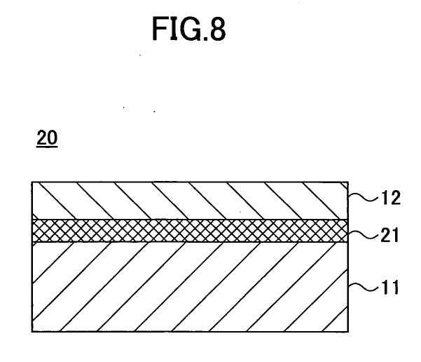

FIG. 8 is a cross-sectional view showing a portion of a molded resin component 20 according to another embodiment of the present invention. In FIG. 8, the molded resin component 20 includes a molded substrate 11 including a biodegradable resin, an adhesive layer 21 covering at least a portion of the surface of the molded substrate 11, and a coating film 12 covering at least a portion of the adhesive layer 21. Other than the adhesive layer 21 included in the molded resin component 20, the configuration of the molded resin component 20 is relatively the same as that of the molded resin component 10 according to the first embodiment of the present invention. By disposing the adhesive layer 21 between the molded substrate 11 and the coating film 12, the adhesion between the molded substrate 11 and the coating film 12 can be enhanced. The adhesive layer 21 is formed by applying and drying an adhesive agent (e.g. a two-part elastic adhesive, a one-part cold setting adhesive, a two-part cold setting epoxy resin adhesive, a reactive acrylic adhesive, an emulsion adhesive, a chloroprene rubber adhesive, a nitrile rubber adhesive, a resin solvent type adhesive, a phenol resin adhesive) on the surface of the molded substrate 11.

The adhesive layer 21 may be formed with a thickness of, for example, approximately 10 μm. The method for applying the adhesive layer 21 may be one of the above-described applying methods employed for coating the coating film 12.

Accordingly, even in a case where the coating film 12 substantially only includes a natural material, the hardness and adhesion of the coating film 12 can be enhanced by providing the adhesive layer 21 in the molded resin component 20 according to the second embodiment of the present invention.

In a case where the coating film formed on a biodegradable molded resin substrate includes only a natural material, the physical hardness of the coating film tends to be lower than that of a coating film including a petroleum coating material. However, the inclusion of the adhesive layer 21 enables the coating film 12 to employ a natural material while still attaining a satisfactory hardness property.

Further, the present invention is not limited to these embodiments, but variations and modifications may be made without departing from the scope of the present invention.

The present application is based on Japanese Priority Application No. 2005-266896 filed on Sep. 14, 2005, with the Japanese Patent Office, the entire contents of which are hereby incorporated by reference.

What is claimed is:

1. A resin molded component comprising:
a molded substrate including a biodegradable resin; and
a coating film applied on a surface of the molded substrate;
wherein the coating film includes a blended material having a petroleum coating material and a natural material blended therein.

2. The resin molded component as claimed in claim 1, wherein the natural material has a biodegradability rate that is greater than that of a synthetic resin included in the petroleum coating material.

3. The resin molded component as claimed in claim 1, wherein the molded substrate and the coating film have an adhesive layer provided therebetween.

4. The resin molded component as claimed in claim 1, wherein the natural material contains a substance obtained from a plant, wherein the substance includes at least one of a sap, a pitch, a tallow, a beeswax, a glue, and an albumen.

5. A resin molded component comprising:
a molded substrate including a biodegradable resin;
an adhesive layer applied on a surface of the molded substrate; and
a coating film applied on a surface of the adhesive layer;
wherein the principal component of the coating film is a coating material including a natural material.

6. The resin molded component as claimed in claim 5, wherein the natural material contains a substance obtained from a plant, wherein the substance includes at least one of a sap, a pitch, a tallow, a beeswax, a glue, and an albumen.
